(19) United States
(12) Patent Application Publication
(10) Pub. No.: US 2014/0085196 A1
(43) Pub. Date: Mar. 27, 2014

(54) Method and System for Secondary Content Distribution

(71) Applicants: Arnold Zucker, Hashmoniam (IL); Avraham Poupko, Jerusalem (IL); Steve Epstein, Hashmonaim (IL); Yossi Tsuria, Jerusalem (IL); Hillel Solow, Beit Shemesh (IL); Shabtai Atlow, Efrat (IL); Kevin A. Murray, Fordingbridge (GB)

(72) Inventors: Arnold Zucker, Hashmoniam (IL); Avraham Poupko, Jerusalem (IL); Steve Epstein, Hashmonaim (IL); Yossi Tsuria, Jerusalem (IL); Hillel Solow, Beit Shemesh (IL); Shabtai Atlow, Efrat (IL); Kevin A. Murray, Fordingbridge (GB)

(73) Assignee: Cisco Technology Inc., San Jose, CA (US)

(21) Appl. No.: 14/115,833

(22) PCT Filed: Apr. 19, 2012
(86) PCT No.: PCT/IB2012/051960

§ 371 Date: Nov. 5, 2013

(30) Foreign Application Priority Data
May 9, 2011 (GB) 1107603.1

(51) Int. Cl. G06F 3/01

(52) U.S. Cl. CPC G06F 3/01
USPC 345/156

(57) ABSTRACT

A secondary content distribution system and method is described, the system and method including a receiver for receiving a plurality of differing versions of secondary content from an provider, each one of the differing versions of the secondary content being associated with at least one of a reading mode, and a connection mode, a processor operative to determine a reading mode of a user of a client device, a selector for selecting one of the differing versions of the secondary content for display on the client device display, the selection being a function, at least in part, of matching the determined reading mode with the reading mode associated with the one of the differing versions of the secondary content and the connection mode of the client device, and a display for displaying the selected one of the differing versions of the secondary content on the client device display. Related methods, systems, and apparatus are also described.

### FIELD OF THE INVENTION

The present invention relates to content distribution systems, and more particularly to secondary content distribution systems.

### BACKGROUND OF THE INVENTION

Common eye movement behaviors observed in reading include forward saccades (or jumps) of various length (eye-movements in which the eye moves more than 40 degrees per second), micro-saccades (small movements in various directions), fixations of various duration (often 250 ms or more), regressions (eye-movements to the left), jitters (shaky movements), and nystagmus (a rapid, involuntary, oscillatory motion of the eyeball). These behaviors in turn depend on several factors, some of which include (but are not restricted to): text difficulty, word length, word frequency, font size, font color, distortion, user distance to display, and individual differences. Individual differences that affect eye-movements further include, but are not limited to, reading speed, intelligence, age, and language skills. For example, as the text becomes more difficult to comprehend, fixation duration increases and the number of regressions increases.

Additionally, during regular reading, eye movements will follow the text being read sequentially. Typically, regular reading is accompanied by repeated patterns of short fixations followed by fast saccades, wherein the focus of the eye moves along the text as the text is laid out on the page being read. By contrast, during scanning of the page, patterns of motion of the eye are more erratic. Typically, the reader's gaze focuses on selected points throughout the page, such as, but not limited to, pictures, titles, and small text segments.

Aside from monitoring eye movement (e.g. gaze tracking) other methods a device may use in order to determine activity of a user include, but are by no means limited to detecting and measuring a page turn rate (i.e. an average rate of turning pages over all pages in a given text); detecting and measuring a time between page turns (i.e. time between page turns for any two given pages); measuring average click speed; measuring a speed of a finger on a touch-screen; measuring a time between clicks on a page; determining an activity of the user of the client device (such as reading a text, scanning a text, fixating on a portion of the text, etc.); determining user interface activity, said user interface activity including, but not limited to searching, annotating, and highlighting text as well as other user interface activity, such as accessing menus, clicking buttons, and so forth; detecting one or both of movement or lack of movement of the client device; detecting the focus of the user of the client device with a gaze tracking mechanism; and detecting background noise.

Recent work in intelligent user interfaces has focused on making computers similar to an assistant or butler in supposing that the computer should be attentive to what the user is doing and should keep track of user interests and needs. It would appear that the next step should be not only that the computer be attentive to what the user is doing and keep track of user interests and needs, but the computer (or any appropriate computing device) should be able to react to the users acts and provide appropriate content accordingly.

The following non-patent literature is believed to reflect of the state of the art:
Eye Movement-Based Human-Computer Interaction Techniques: Toward Non-Command Interfaces R. Jacob, Advances in Human-Computer Interaction, pp. 151-190. Ablex Publishing Co. (1993);
Toward a Model of Eye Movement Control in Reading, Erik D. Reichle, Alexander Pollatsek, Donald L. Fisher, and Keith Rayner Psychological Review 1998, Vol. 105, No. 1, 125-157;
Eye Tracking Methodology, Theory and Practice, Andrew Duchowski, second edition, Part II, Chapters 5-12, and Part IV, Chapter 19. Springer-Verlag London Limited, 2007;
What You Look at is what You Get: Eye Movement-Based Interaction Techniques, Robert J. K. Jacob, in Proceedings of the SIGCHI conference on Human factors in Computing Systems: Empowering People (CHI '90) 1990, Jane Carrasco Chew and John Whiteside (Eds.). ACM, New York, N.Y., USA, 11-18; and
A Theory of Reading: From Eye Fixations to Comprehension Marcel A. Just, Patricia A. Carpenter, Psychological Review, Vol 87(4), July 1980, 329-354.

The following patents and patent applications are believed to reflect the state of the art:
U.S. Pat. No. 5,731,805 to Tognazzini et al.;
U.S. Pat. No. 6,421,064 to Lemelson et al.;
U.S. Pat. No. 6,725,203 to Seet et al.;
U.S. Pat. No. 6,873,314, to Campbell;
U.S. Pat. No. 6,886,137 to Peck et al.;
U.S. Pat. No. 7,205,959 to Henriksson;
U.S. Pat. No. 7,429,108 to Rosenberg;
U.S. Pat. No. 7,438,414 to Rosenberg;
U.S. Pat. No. 7,561,143 to Milekic;
U.S. Pat. No. 7,760,910 to Johnson et al.;
U.S. Pat. No. 7,831,473 to Myers, et al.;
US 2001/0007980 of Ishibashi et al.;
US 2003/0038754 of Goldstein, et al.;
US 2005/0047629 of Farrell, et al.;
US 2005/0108092 of Campbell et al.;
US 2007/0255621 of Mason;
US 2008/208690 of Lim;
US 2009/0179853 of Beale;
KR 20100021702 of Rhee Phill Kyu:
EP 2141614 of Hilgers;
WO 2008/154451 of Wu; and
WO 2008/101152 of Wax.

### SUMMARY OF THE INVENTION

There is thus provided in accordance with an embodiment of the present invention a secondary content distribution system including a receiver for receiving a plurality of differing versions of secondary content from an provider, each one of the differing versions of the secondary content being associated with at least one of a reading mode, and a connection mode, a processor operative to determine a reading mode of a user of a client device, a selector for selecting one of the differing versions of the secondary content for display on the client device display, the selection being a function, at least in part, of matching the determined reading mode with the reading mode associated with the one of the differing versions of the secondary content and the connection mode of the client device, and a display for displaying the selected one of the differing versions of the secondary content on the client device display.

Further in accordance with an embodiment of the present invention the system according to claim 1 and also including selecting and displaying differing versions of primary content depending, at least in part, on the determined reading mode.

Still further in accordance with an embodiment of the present invention and wherein the different versions of the secondary content include any of content items which change into a different content item, content items which occupy a fixed area on a display of the client, content items which persist over more than one page, and content including an audio component, the audio component persisting as the user of the client device changes pages.

Additionally in accordance with an embodiment of the present invention and wherein the different versions of the secondary content include any of video content, audio content, automated files, banner content, different size content items, different video playout rates, static content, and content which change when at least one of the reading mode of the user of the client device changes, and the connection mode of the client device changes.

Moreover in accordance with an embodiment of the present invention the secondary content is displayed on an alternative device.

Further in accordance with an embodiment of the present invention the reading mode of the user of the client device includes one of flipping quickly through pages displayed on the client device, interfacing with the client device, perusing content displayed on the client device, and concentrated reading of the content displayed on the client device.

Still further in accordance with an embodiment of the present invention the processor determines the reading mode of the user, based at least in part on any of detecting and measuring a page turn rate, detecting and measuring a time between page turns, measuring average click speed, measuring a speed of a finger on a touch-screen, measuring a time between clicks on a page, determining an activity of the user of the client device, determining user interface activity, the user interface activity including, but not limited to searching, annotating, and highlighting text, detecting one or both of movement or lack of movement of the client device, detecting the focus of the user of the client device with a gaze tracking mechanism, and detecting background noise.

Additionally in accordance with an embodiment of the present invention the connection mode is dependent on availability of any of bandwidth, and connectivity to a network over which the secondary content is provided.

Moreover in accordance with an embodiment of the present invention the client device includes one of a cell-phone, an e-Reader, a laptop computer, a desktop computer, a tablet computer, a game console, a music playing device, and a video playing device.

There is also provided in accordance with another embodiment of the present invention a system for selecting a secondary content to display, the system including a secondary content preparing unit for preparing a plurality of different versions of an secondary content, a processor for associating each one of the plurality of differing versions of the secondary content with at least one of a reading mode, and a connection mode, and a secondary content sender for sending the differing versions of the secondary content to at least one client device, wherein the at least one client device is operative to select one of the plurality of differing versions of the secondary content for display based, at least in part, on a determined reading mode of a user of the client device, and the connection mode of the client device and thereupon to display the selected secondary content.

Further in accordance with an embodiment of the present invention the different versions of the of the secondary content include any of content items which change into a different content item, content items which occupy a fixed area on a display of the client, content items which persist over more than one page, and content items including an audio component, the audio component persisting as the user of the client device changes pages.

Still further in accordance with an embodiment of the present invention the different versions of the secondary content include any of video content, audio content, automated files, banner content, different size content items, static content, and content which changes when at least one of the reading mode of the user of the client device changes, and the connection mode of the client device changes.

Additionally in accordance with an embodiment of the present invention the reading mode of the user of the client device includes one of flipping quickly through pages displayed on the client device, interfacing with the client device, perusing content displayed on the client device, and concentrated reading of the content displayed on the client device.

Moreover in accordance with an embodiment of the present invention the determined reading mode includes a determination, based at least in part on any of one of detecting and measuring a page turn rate, one of detecting and measuring a time between page turns, measuring average click speed, measuring a speed of a finger on a touch-screen, measuring a time between clicks on a page, determining an activity of the user of the client device, determining user interface activity, the user interface activity including, but not limited to searching, annotating, and highlighting text, detecting one or both of movement or lack of movement of the client device, detecting the focus of the user of the client device with a gaze tracking mechanism, and detecting background noise.

Further in accordance with an embodiment of the present invention the connection mode is dependent on availability of any of bandwidth, and connectivity to a network over which the secondary content is provided.

Further in accordance with an embodiment of the present invention the client device includes one of a cell-phone, an e-Reader, a laptop computer, a desktop computer, a tablet computer, a music playing device, and a video playing device.

There is also provided in accordance with still another embodiment of the present invention a secondary content distribution method including receiving at a receiver a plurality of differing versions of secondary content from an provider, each one of the differing versions of the secondary content being associated with at least one of a reading mode, and a connection mode, determining at a processor a reading mode of a user of a client device, selecting at a selector for selecting one of the differing versions of the secondary content for display on the client device display, the selection being a function, at least in part, of matching the determined reading mode with the reading mode associated with the one of the differing versions of the secondary content and the connection mode of the client device, and displaying the selected one of the differing versions of the secondary content on the client device display.

There is also provided in accordance with still another embodiment of the present invention a method for selecting a secondary content to display, the method including preparing a plurality of different versions of an secondary content at a secondary content preparing unit, associating, at a processor, each one of the plurality of differing versions of the secondary content with at least one of a reading mode, and a connection mode, and sending the differing versions of the secondary content to at least one client device, wherein the at least one client device is operative to select one of the plurality of differing versions of the secondary content for display based, at least in part, on a determined reading mode of a user of the client device, and the connection mode of the client device and thereupon to display the selected secondary content.

### BRIEF DESCRIPTION OF THE DRAWINGS

The present invention will be understood and appreciated more fully from the following detailed description, taken in conjunction with the drawings in which:

FIG. 1 is a simplified pictorial illustration of a user using a client device in various different reading modes, the client device constructed and operative in accordance with an embodiment of the present invention;

FIG. 2 is a pictorial illustration of a client device on which primary and secondary content is displayed, in accordance with the system of FIG. 1;

FIG. 3 is a block diagram illustration of a client device in communication with a provider of secondary content, operative according to the principles of the system of FIG. 1;

FIG. 4 is a block diagram illustration of a typical client device within the system of FIG. 1;

FIG. 5 is a block diagram illustration of a provider of secondary content in communication with a client device, operative according to the principles of the system of FIG. 1;

FIG. 6 is a flowchart which provides an overview of the operation of the system of FIG. 1;

FIG. 7 is a block diagram illustration of alternative embodiment of the client device of FIG. 1;

FIG. 8 is an illustration of a system of implementation of the alternative embodiment of the client device of FIG. 7;

FIG. 9 is a figurative depiction of layering of various content elements on the display of the client device of FIG. 1;

FIG. 10 is a depiction of typical eye motions made by a user of the client device of FIG. 1;

FIG. 11 is a figurative depiction of the layered content elements of FIG. 9, wherein the user of the client device is focusing on the displayed text;

FIG. 12 is a figurative depiction of the layered content elements of FIG. 9, wherein the user of the client device is focusing on the graphic element;

FIG. 13 is a depiction of an alternative embodiment of the client device of FIG. 1;

FIGS. 14A, 14B, and 14C are a depiction of another alternative embodiment of the client device of FIG. 1;

FIG. 15 is a pictorial illustration of transitioning between different secondary content items in accordance with the system of FIG. 1;

FIGS. 16A and 16B are a depiction of a transition between a first secondary content item and a second secondary content item displayed on the client device of FIG. 1; and

FIGS. 17-23 are simplified flowchart diagrams of preferred methods of operation of the system of FIG. 1.

### DETAILED DESCRIPTION OF AN EMBODIMENT

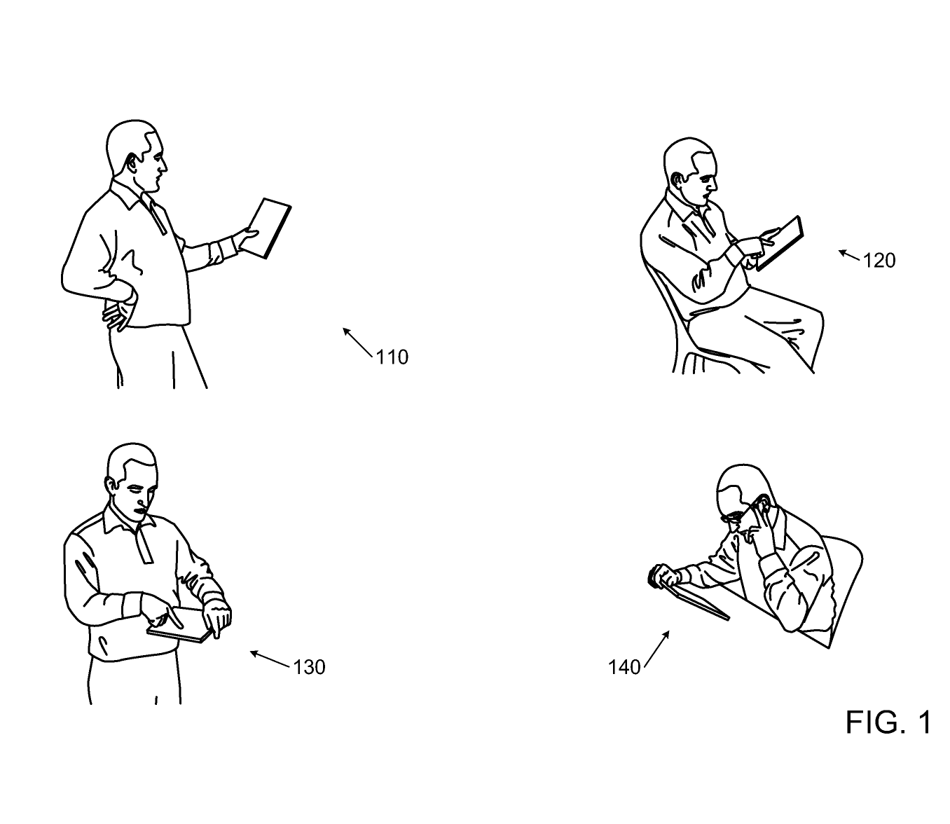

Reference is now made to FIG. 1, which is a simplified pictorial illustration of a user using a client device in various different reading modes, the client device constructed and operative in accordance with an embodiment of the present invention.

The user depicted in FIG. 1 is shown in four different poses. In each one of the four different poses, the user is using the client device in a different reading mode. In the first reading mode 110, the user is flipping quickly through pages displayed on the client device. In the second reading mode 120, the user is slowly browsing content on the client device. In the third reading mode 130, the user is interfacing with the client device. In the fourth reading mode 140, the user is engaged in concentrated reading of content on the client device.

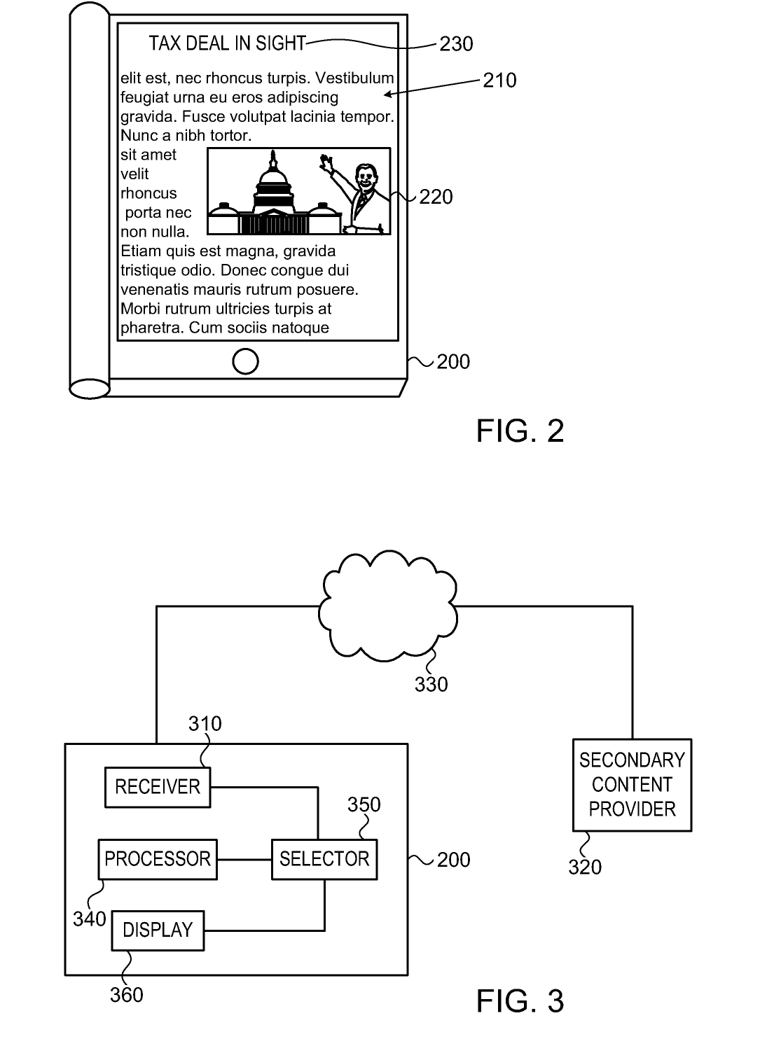

Reference is now additionally made to FIG. 2, which is a pictorial illustration of a client device 200 on which primary content 210 and secondary content 220 is displayed, in accordance with the system of FIG. 1. The client device 200 may be a consumer device, such as, but not limited to, a cell-phone, an e-reader, a music-playing or video-displaying device, a laptop computer, a game console, a tablet computer, a desktop computer, or other appropriate device.

The client device 200 typically operates in two modes: connected to a network; and not connected to the network. The network may be a WiFi network, a 3G network, a local area network (LAN) or any other appropriate network. When the client device 200 is connected to the network, primary content 210 is available for display and storage on the client device. Primary content 210 may comprise content, such as, but not limited to news articles, videos, electronic books, text files, and so forth.

It is appreciated that the ability of the client device to download and display the content is, at least in part, a function of bandwidth available on the network to which the client device 200 is connected. Higher bandwidth enables faster downloading of primary content 210 and secondary content 220 (discussed below) at a higher bit-rate.

Alternatively, when the client device 200 is not connected to the network, the client device is not able to download content. Rather, what is available to be displayed on a display comprised in the client device 200 is taken from storage comprised in the client device 200. Those skilled in the art will appreciate that storage may comprise hard disk drive type storage, flash drive type of storage, a solid state memory device, or other device used to store persistent data.

The client device 200 is also operative to display secondary content 220, the secondary content 220 comprising content which is secondarily delivered in addition to the primary content 210. For example and without limiting the generality of the foregoing, the secondarily delivered 220 content may comprise any appropriate content which is secondarily delivered in addition to the primary content 210, including video advertisements; audio advertisements; animated advertisements; banner advertisements; different sized advertisements; static advertisements; and advertisements designed to change when the reading mode changes. Even more generally, the secondary content may be any appropriate video content; audio content; animated content; banner content; different sized content; static content; video content played at different video rates; and content designed to change when the reading mode changes.

Returning now to the discussion of the reading modes of FIG. 1, in the first reading mode 110, the user is flipping quickly through pages displayed on the client device 200. When a user flips quickly through primary content 210 (such as, but not limited to the pages of a digital magazine), secondary content 220 (such as an attention-grabbing graphic) may be more appropriate secondary content 220 than, for example and without limiting the generality of the foregoing, a text-rich advertisement in this particular reading mode. Another example is a “flip-book” style drawing that appears at the bottom corner of the page which seems to animate as the display advances rapidly from page to page—this capitalizes on the user's current activity and provides an interesting advertising medium. The “flip-book” animation effect may disappear once the page-turn rate decreases to below a certain speed. For example and without limiting the generality of the foregoing, if there are three page turns within two seconds of each other, then flip-book type reading might be appropriate. Once five to ten seconds have gone by without a page turn, however, the user is assumed to have exited this mode.

Turning now to the second reading mode 120 of FIG. 1, the user is slowly browsing (perusing) primary content 210 on the client device 200. When perusing primary content 210 such as headlines 230 (and perhaps reading some primary content 210, but not in a concentrated or focused manner) animated secondary content 220 such as an animated advertisement, may be more effective than static animated secondary content 220.

Turning now to the third reading mode 130 of FIG. 1, the user is interfacing with the client device 200. When the user actively interfaces with the client device 200, for example, performing a search of the primary content 210, or annotating or highlighting text comprised in the primary content 210, since the user is not reading an entire page of primary content 210, but rather, the user is focused only on a specific section of the primary content 210 or the client device 200 user interface, automatic positioning of the secondary content 220 in relation to the position of the activity on the client device 200 may aid the effectiveness of the secondary content 220.

Turning now to the fourth reading mode 140 of FIG. 1, the user is engaged in concentrated reading of the primary content 210 on the client device 220. During focused reading of the primary content 210, secondary content 220 such as an animated flash advertisement on the page can be distracting and even annoying, whereas secondary content 220 such as a static graphic-based advertisement may nonetheless be eye-catching and less annoying to the user.

In short, the secondary content 210 which is delivered to the client device 200 is appropriate to the present reading mode of the user of the client device 200. When using a client device 200 such as, but not limited to a cell phone, an e-book reader, a laptop computer, a tablet computer, a desktop computer, a device which plays music or videos, or other similar devices, users may enter many different “reading modes” during one session. Therefore, it is important for a client device 200 application to automatically adapt when the user changes reading modes.

In addition, the client device 200 is also operative to display different versions of the secondary content 220 depending on a connection mode of the client device 200. For example, the client device 200 may be connected to a WiFi network, and the network is able to provide a high bandwidth connection. Alternatively, the client device 200 may be connected to a 3-G network, which provides a lower bandwidth connection than a WiFi network. Still further alternatively, if the client device is not connected to any network, secondary content 220 may be selected from secondary content 220 stored in storage of the client device.

Thus, when the client device 200 is connected to the WiFi network, the secondary content 220 displayed may comprise high quality video. Alternatively, if the client device 200 is connected to the 3-G network, a low quality video may be displayed as the secondary content 220. Still further alternatively, if the client device is not connected to any network, any secondary content 220 stored on the client device 200 may be displayed.

Those skilled in the art will appreciate that if the secondary content 220 stored on the client device 200 connected, for example to a 3-G network, is of a higher quality than the secondary content 220 available over the 3-G network, the client device 200 may display the stored secondary content 220.

A processor comprised in the client device 200, using various techniques, determines the present engagement of the user with the client device 200 in order to determine the reading mode. These techniques include, but are not necessarily limited to:

detecting and measuring a page turn rate (i.e. an average rate of turning pages over all pages in a given text);

detecting and measuring a time between page turns (i.e. time between page turns for any two given pages);

measuring average click speed;

measuring a speed of a finger on a touch-screen;

measuring a time between clicks on a page;

determining an activity of the user of the client device, such as, but not limited to, reading a text, scanning a text, fixating on a portion of the text, etc.;

determining user interface activity, said user interface activity including, but not limited to searching, annotating, and highlighting text, accessing menus, clicking buttons, etc.;

detecting one or both of movement or lack of movement of the client device;

detecting the focus of the user of the client device with a gaze tracking mechanism; and

detecting background noise.

A provider of the secondary content 220 prepares secondary content 220 such that each secondary content item is associated with a particular content item. For example, a particular secondary content item might be associated with the first reading mode 110, in which the user is flipping quickly through pages displayed on the client device 200. A second particular secondary content item might be associated with second reading mode 120, in which the user is slowly browsing (perusing) primary content 210 on the client device 200. A third particular secondary content item might be associated with the third reading mode 130, in which the user is interfacing with the client device 200. A fourth particular secondary content item might be associated with the fourth reading mode 140, in which the user is engaged in concentrated reading of the primary content 210 on the client device 220.

Once the client device 200, using the techniques detailed above, determines the present reading mode of the user or alternatively, once the client device 200 determines a change in the user's reading mode, the client device 200 one of displays or switches to an appropriate version of the secondary content 220 that matches the reading mode 110, 120, 130, 140 of the user. As was noted above, the connectivity mode of the client device 200 may also be, either partially or totally, a factor in the selection of the secondary content displayed by the client device 200.

For example and without limiting the generality of the foregoing, placement of secondary content 220 is adapted to the present reading mode 110, 120, 130, 140 of user of the client device 200. Thus, if the user is flipping through the primary content 210, all of the advertisements and other secondary content 220 on those pages which are flipped through may be replaced by the client device 200 by a multi-page, graphic-rich series of advertisements.

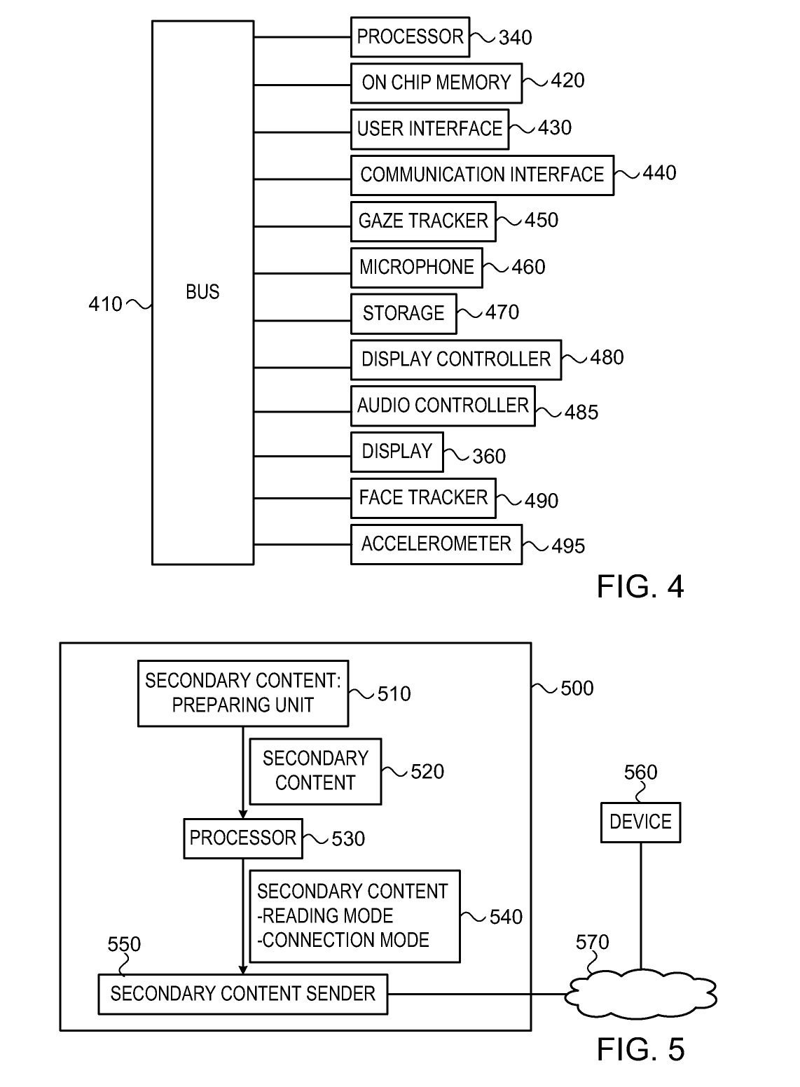

Reference is now made to FIG. 3, which is a block diagram illustration of a client device 200 in communication with a provider 320 of secondary content 220, operative according to the principles of the system of FIG. 1. The client device 200 comprises a receiver 310 which receives secondary content 220 from the secondary content provider 320. The client device 200 is discussed in greater detail below, with reference to FIG. 4. The operation of the secondary content provider 320 is discussed in greater detail below, with reference to FIG. 5.

The receiver 310 is in communication with the secondary content provider 320 over a network 330. The network mentioned above, with reference to FIGS. 1 and 2 may be in direct communication with both the secondary content provider 320 and the client device, such as a case where the client device 200 and the secondary content provider 320 are connected to the same network. Alternatively, the network mentioned above may be connected to another network 330 (such as the Internet) which carries communications between the client device 200 and the secondary content provider 320.

Regardless of the precise nature of and routing within the local network (of FIGS. 1 and 2) and the wider network 330, the secondary content provider 320 provides secondary content 220 (FIG. 2) to the client device.

The client device 200 comprises a processor which, among other functions, determines a reading mode of a user of a client device 200, as described above. The processor signals a selector 350 as to what is the determined reading mode.

The selector 350 selects one of the differing versions of the secondary content 220 received by the receiver 310 for display on a display 360 comprised in the client device 200. As discussed above, the selection of one of the differing versions of the secondary content 22,0 is a function, at least in part, of matching the determined reading mode of the user of the client device 200 with the reading mode associated with the one of the differing versions of the secondary content 200 and the connection mode of the client device.

Reference is now made to FIG. 4, which is a block diagram illustration of a typical client device 200 within the system of FIG. 1. In addition to the processor 340 and the display 360, mentioned above, the client device comprises a communication bus 410, as is known in the art. The client device 200 typically also comprises on chip memory 420, a user interface 430, a communication interface 440, a gaze tracking system 450, and internal storage 470 (as discussed above). A microphone 460 may also optionally be comprised in the client device 200.

It is appreciated that the receiver 310 of FIG. 3 may be comprised in the communication interface 440. The selector 350 of FIG. 3 may be comprised in the processor 340 or other appropriate system comprised in the client device. The display 360 is typically controlled by a display controller 480. The device also may comprise an audio controller 485 operative to control audio output to a speaker (not depicted) comprised in the client device 200.

In addition, some embodiments of the client device 200 may also comprise a face tracker 490. The face tracking system 490 is distinct from the gaze tracking system 450, in that gaze tracking systems typically determine and track the focal point of the eyes of the user of the client device 200. The face tracking system 490, by contrast, typically determine the distance of the face of the user of the client device 200 from the client device 200.

Embodiments of the client device 200 may comprise an accelerometer 495, operative to determine orientation of the client device 200.

Reference is now made to FIG. 5, which is a block diagram illustration of a provider of secondary content in communication with a client device, operative according to the principles of the system of FIG. 1. As discussed above, with reference to FIGS. 1 and 2, different secondary content items are associated with different reading modes. The secondary content provider 500 comprises a system 510 for preparing secondary content 520. It is appreciated that the system 510 for preparing secondary content 520 may, in fact, be external to the secondary content provider 500. For example and without limiting the generality of the foregoing, the secondary content provider 500 may be an advertisement aggregator, and may receive prepared advertisements from advertising agencies or directly from advertisers. Alternatively, system 510 for preparing secondary content 520 may be comprised directly within the secondary content provider 500.

The secondary content 520 is sent from the system 510 for preparing secondary content 520 to a processor 530. The processor 530 associates each input secondary content item 540 with a reading mode and a connection mode, as described above. Once each secondary content item 540 is associated with a secondary content item appropriate reading mode and connection mode, the secondary content item 540 is sent, via a secondary content sender 550 to the various client devices 560 over a network 570. The nature of the network 570 has already been discussed above with reference to the network 330 of FIG. 3.

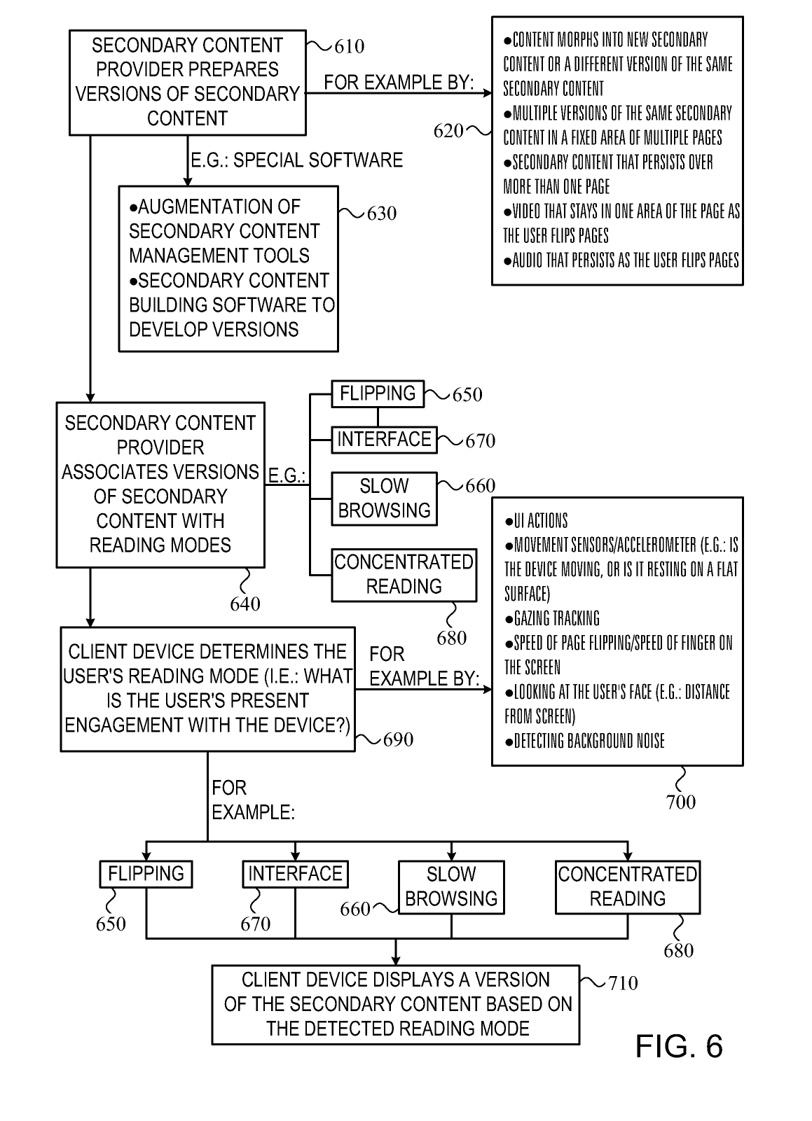

Reference is now made to FIG. 6 which is a flowchart which provides an overview of the operation of the system of FIG. 1. The secondary content provider prepares different versions of secondary content (step 610). For example, the secondary content morphs into new secondary content or, alternatively, a different version of the same secondary content; multiple versions of the same secondary content which appears in a fixed area of multiple pages; secondary content may persist over more than one page of primary content; secondary content comprises video which stays in one area of the page as the user flips through pages of the primary content; and secondary content comprises audio which persists as the user flips through pages of the primary content (step 620).

The preparation of the secondary content may entail development of secondary management tools; and secondary content building tools (step 630).

The secondary content provider associates different versions of the secondary content with different reading modes of the user (step 640), such as the first reading mode, flipping 650; the second reading mode, browsing 660; the third reading mode, interfacing with the client device 670; and the fourth reading mode, concentrated reading 680. It is appreciated that in some embodiments of the present invention, primary content may also change, dependent on reading mode.

The client device determines the user's reading mode (that is to say, the client device determines the user's present engagement with the client device) (step 690). Different user's reading modes have already been mentioned above as flipping 650; browsing 660; interfacing 670; and concentrated reading 680. For example, the client device determines the user's interactions with the client device user interface; the client device relies on readings and input from movement sensors and accelerometers (for instance is the client device moving or is the client device resting on a flat surface); the client device utilizes gaze tracking tools to determine where the user's gaze is focused; the client device determines the speed of page flipping and/or the speed of the user's finger on the client device touch screen; the client device determines the distance of the user's face from the client device display screen; and the client device monitors the level of the background noise (step 700).

The client device displays a version of the secondary content depending on the detected reading mode (step 710). It is appreciated that in some embodiments of the present invention, primary content may also change, dependent on reading mode.

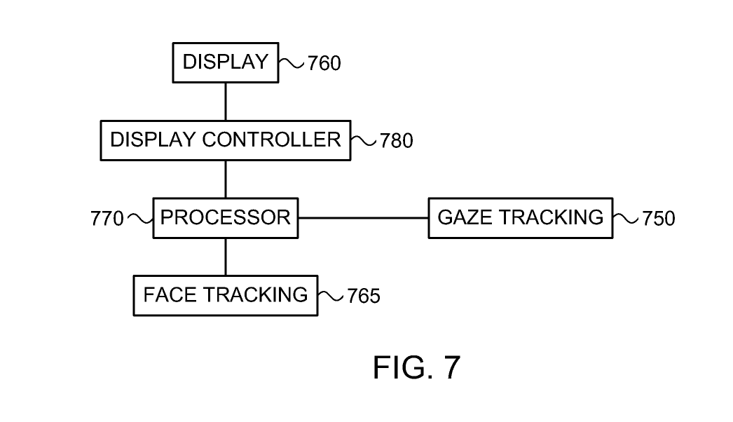

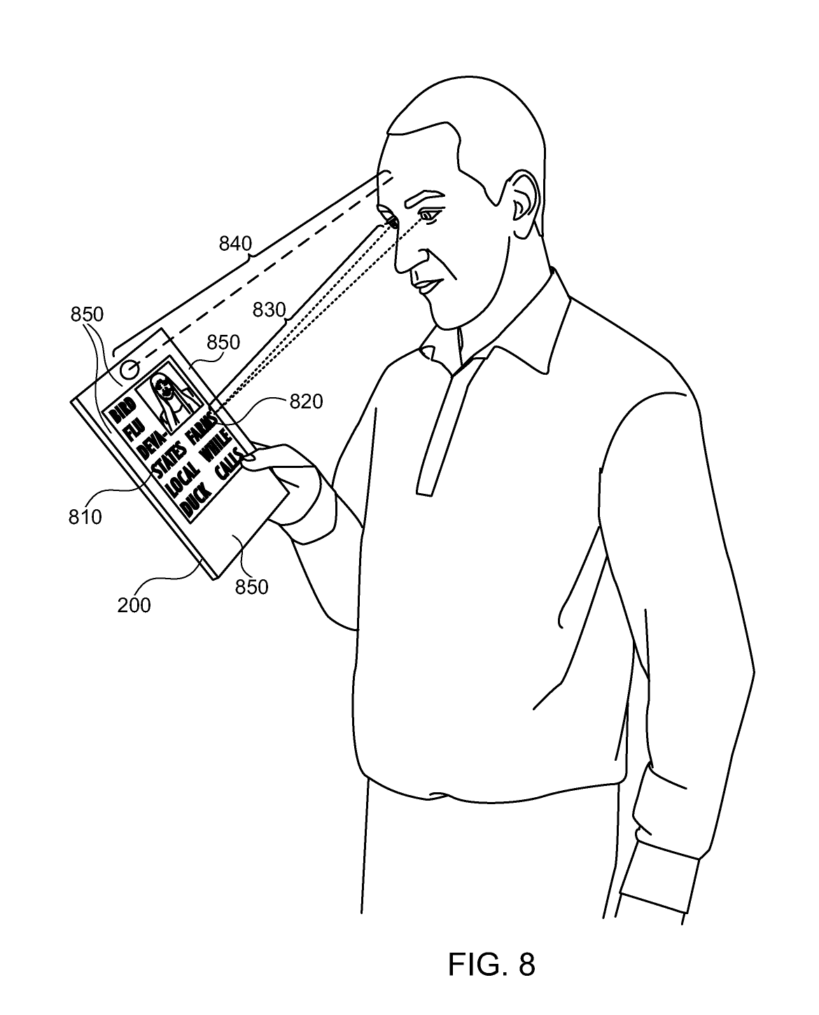

Reference is now made to FIG. 7, which is a block diagram illustration of alternative embodiment of the client device 200 of FIG. 1. Reference is additionally made to FIG. 8, which is an illustration of a system of implementation of the alternative embodiment of the client device 200 of FIG. 7.

The embodiment of the client device 200 depicted in FIG. 7 is designed to enable the user of the client device 200 to read text 810 which might be displayed in a fashion which is difficult to read on the display of the client device 200. It might be the case that there is a large amount of text 810 displayed, and the text 810 is laid out to mimic the appearance of a newspaper, such that text is columnar and of varying sizes. In such cases, or similar cases, when the user moves the client device 200 closer to, or further from, his face, the text 810 appears to zoom in or zoom out, as appropriate. (It is appreciated that the amount of zoom might be exaggerated or minimized in some circumstances.) Therefore when the user focuses on a particular textual article or other content item which appears on the display of the client device 200, the client device 200 appears to zoom in to the text 810 of that article. If the user focuses on a content trigger point (such as, but not limited to, a start or play ‘hot spot’ which activates a video, a slide show, or a music clip—trigger points are often depicted as large triangles, with their apex pointed to the right), the content activated by the content trigger point is activated.

In some embodiments of the client device 200, there is a button or other control which the user actuates in order to activate (or, alternatively, to deactivate) dynamic user zooming by the client device 200. Alternatively, a slider or a touching a portion of a touch screen may be used to activate, deactivate, or otherwise control dynamic user zooming by the client device 200. Furthermore, a prearranged hand or facial signal may also be detected by an appropriate system of the client device, and active (or deactivate) dynamic user zooming by the client device 200.

The client device 200 comprises a gaze tracking system 750. The gaze tracking system 750 is operative to track and identify a point 820 on the client device 200 display 760 to which a user of the client device 200 is directing the user's gaze 830. The client device 200 also comprises a face tracking system 765. The face tracking system 765 is operative to determine a distance 840 of the face of the user of the client device 200 from the display 760.

The client device 200 further comprises a processor 770 which receives from the gaze tracking system 750 a location of the point 820 on the display as an input. The processor 770 also receives from the face tracking system 765 the determined distance 840 of the face of the user from the client device 200. The processor 770 is operative to output an instruction to a device display controller 780. The device display controller 780, in response to the instruction, is operative to perform one of the following:

zoom in on the point 820 on the display; and

zoom out from the point 820 on the display.

The display controller 780 zooms in on the point 820 when the point 820 comprises a point 820 which, as a result of the determination of the face tracking system 765, is moving closer to the user's face, and the display controller 780 zooms out from the point 820 when the point 820 comprises a point 820 which, as a result of the determination of the face tracking system 765, is moving farther from the user's face.

When the user focuses on the frame 850 of the client device 200 or the margins of the page for an extended period, the view scrolls to the next page or otherwise modifies the display of the device in a contextually appropriate fashion, as will be appreciated by those skilled in the art. The image which is displayed on the display (such as the text 810, or the content item) automatically stabilizes as the user moves, so that any movement of the page (that is to say the client device 200) keeps the text 810 at the same view. One implementation of this feature is as follows: just as an image projected onto a screen remains constant, even if the screen is pivoted right or left, so too the image on the client device 200 remains constant even if the client device 200 is pivoted laterally.

An alternative implementation is as follows: the image/text 810 on the client device 200 display is maintained at a steady level of magnification (zoom) in relation to the user's face. For example, a user making small and or sudden movements (e.g. unintentionally) getting further from or closer to the client device 200 will perceive a constant size for the text 810. This is accomplished by the client device 200 growing or shrinking the text 810 as appropriate, in order to compensate for the change in distance. Similarly the client device 200 compensates for any of skew; rotation; pitch; roll; and yaw.

Detection of sudden movement of both lateral and angular nature can be achieved using one of more of the following:
a gravity detector (not depicted) comprised in the client device 200 knows the orientation of the client device 200 in all three plains (x, y, and z);
an accelerometer 495 (FIG. 4) provides an indication as to the direction of lateral movement as well as the tilt in all three directions. The accelerometer 495 (FIG. 4) gives the client device 200 information about sudden movement;
the eye tracking system captures movement that is sudden and not characteristic of eye movement;
a compass in the client device 200 helps to detect changes in orientation.

Compensation for movement of the client device 200 is performed in the following manner:
the user performs initial calibration and configuration in order to get the parameters right (for instance, the user can be requested to read one paragraph in depth, then to scan a second paragraph/The user might then be asked to hold the device at a typical comfortable reading distance for the user, and so forth.);
for lateral movement, the image/text 810 on the client device 200 display moves in a direction opposite to the lateral movement, such that the position of the image/text 810 on the client device 200 display is preserved;
for angular movement of the client device 200 in the plane perpendicular to the angle of reading, the image/text 810 on the client device 200 display is rotated in an manner opposite to the angular movement in order to compensate for the rotation; and
for angular movement of the client device 200 in a plane that is parallel to the angle of reading, the image/text 810 on the client device 200 is tilted in the direction opposite to the angular movement in order to compensate for the rotation. Those skilled in the art will appreciate that this compensation needs to be done by proper graphic manipulation, such as rotation transformations, which are known in the art.

It is appreciated that in order to calculate the correct movement of the client device 200 in any direction, it is important to know the distance of the device from the reader's eyes 840, as discussed above. As such, an approximation of the distance of the device from the reader's eyes 840 can be calculated by triangulation, based on the angle between the user's two eyes and the current focus point on the display of the client device 200, based on an average of between 6-7 cm between the user's two eyes. Thus, changes in the distance of the device from the reader's eyes 840 can be determined based on changes in the angle.

As explained above, the client device 200 is sensitive enough to detect a shift in the point 820 of the user's focus to another place on the screen. However, not every shift of focus is intentional. For example:
the user may become distracted and look away from the screen;
bumps in the road may cause a user travelling in a car or bus to unintentionally move the client device 200 closer to or further away from his face; and
the user may shift in his chair or make small movements (say, if the user's arms are not perfectly steady).

Accordingly, the client device 200 comprises a “noise detection” feature in order to eliminate unintentional zooming. Over time the client device 200 learns to measure the user's likelihood to zoom unintentionally. Typically, there will be a ‘training’ or ‘calibration’ period, during which time, when the user moves the client device 200 and the device zooms the user can issue a correction to indicate that ‘this was not an intentional zoom’. Over time, the device will, using know heuristic techniques, more accurately determine what was an intentional zoom and what was an unintentional zoom.

As was noted above, during regular reading, eye movements will follow the text being read sequentially. Typically, regular reading is accompanied by repeated patterns of short fixations followed by fast saccades, wherein the focus of the eye moves along the text as the text is laid out on the page being read. By contrast, during scanning of the page, patterns of motion of the eye are more erratic. Typically, the reader's gaze focuses on selected points throughout the page, such as, but not limited to, pictures, titles, and small text segments.

Accordingly, in another embodiment of the present invention, the client device 200 determines, using the features described above, whether the user of the client device 200 is reading (i.e. the client device 200 detects short fixations followed by fast saccades) or whether the user of the client device 200 is scanning (i.e. the client device 200 detects that the user's gaze focuses on selected points throughout the page, such as, but not limited to, pictures, titles, and small text segments).

When the client device 200 determines that the user is in scanning mode, the user interface or the output of the device is modified in at least one of the following ways:
images and charts which are displayed on the client device 200 are displayed “in focus” or sharp and readable;
if an audio is accompanying text displayed on the client device 200, the audio is stopped (alternatively, the audio could be replaced by a background sound);
when the user makes a fixation over a video window, the video is started, if the user makes a fixation on another point in the screen, the video is paused;
title headers are outlined and keywords are highlighted; and
when the user makes a fixation over an activation button, a corresponding pop-up menu is enabled.

When the client device 200 determines that the user is in reading mode, the user interface or the output of the device is modified in at least one of the following ways:
images and charts which are displayed on the client device 200 are displayed blurred and faded;
text-following audio is activated;
videos presently being played are paused;
outlining of title headers and highlighting of keywords are removed;
pop-up menus are closed; and
text is emphasized and is more legible.

In still another embodiment of the client device 200, the client device 200 determines on which point on the display of the client device 200 the user is focusing. The client device 200 is then able to modify the display of the client device 200 in order to accent, highlight, or bring into focus elements on the display, while alternatively making other elements on the display on which the user is not focusing.

For example and without limiting the generality of the foregoing, if a magazine page displayed on the client device 200 contains text that is placed over a large full page image, the reader (i.e. the user of the client device 200) may be looking at the image, or may be trying to read the text. If the movement of the user's eyes match a pattern for image viewing, the text will fade somewhat, making it less noticeable, while the image may become more focused, more vivid, etc. As the user starts to read the text, the presently described embodiment of the present invention would detect this change in the reading mode of the user. The client device 200 would simultaneously make the text more pronounced, while making the image appear more washed out, defocused, etc.

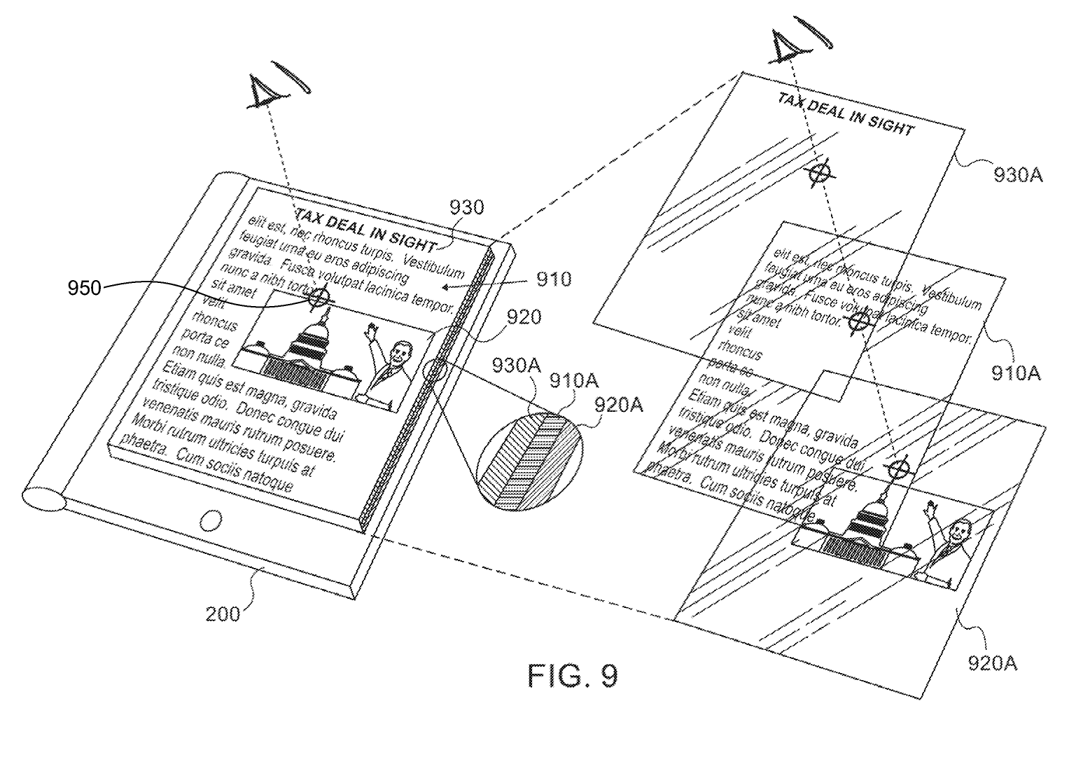

Reference is now made to FIG. 9, which is a figurative depiction of layering of various content elements on the display 910 of the client device 200. During content preparation, content editing tools, such as are known in the art, are used to specify different layers of the content 910A, 920A, 930A. The different layers of content 910A, 920A, 930A are configured to be displayed as different layers of the display of the client device 200. Those skilled in the art will appreciate that the user of the client device 200 will perceive the different layers of the display 910A, 920A, 930A as one single display. As was noted above, the client device 200 comprises a display on which are displayed primary content 910, secondary content 920, and titles, such as headlines 930. As was also noted above, the secondary content 920 comprising content which is secondarily delivered in addition to the primary content 910. For example and without limiting the generality of the foregoing, the secondarily delivered 920 content may comprise any appropriate content which is secondarily delivered in addition to the primary content 910, including video advertisements; audio advertisements; animated advertisements; banner advertisements; different sized advertisements; static advertisements; and advertisements designed to change when the reading mode changes. Even more generally, the secondary content may be any appropriate video content; audio content; animated content; banner content; different sized content; static content; and content designed to change when the reading mode changes.

The different layers of content are typically arranged so that the titles/headlines 930 are disposed in a first layer 930A of the display; the primary content 910 is disposed in a second layer 910A of the display; and the secondary content 920 is disposed in a third layer 920A of the display.

As will be discussed below in greater detail, each layer of the display 910, 920, 930, can be assigned specific behaviors for transition between reading modes and specific focus points. Each layer of the display 910, 920, 930 can be designed to become more or less visible when viewing mode changes, or when the user is looking at components on that layer, or, alternatively, not looking at components on that layer.

One of several systems for determining a point 950 on which the reader's gaze (see FIG. 4, items 450, 490) is currently focused can be used to trace user gaze and enable determining the Viewing Mode.

The processor 340 (FIG. 4) receives inputs comprising at least:
the recent history of the reader's gaze;
device orientation (as determined, for example and without limiting the generality of the foregoing, by the accelerometer 495 (FIG. 4)); and
distance of the reader's face from the device.

The processor determines both:

on which entity on the screen the reader is focusing on; and

in which mode of viewing the user of the client device is engaged, for example and without limiting the generality of the foregoing, reading, skimming, image viewing, etc.

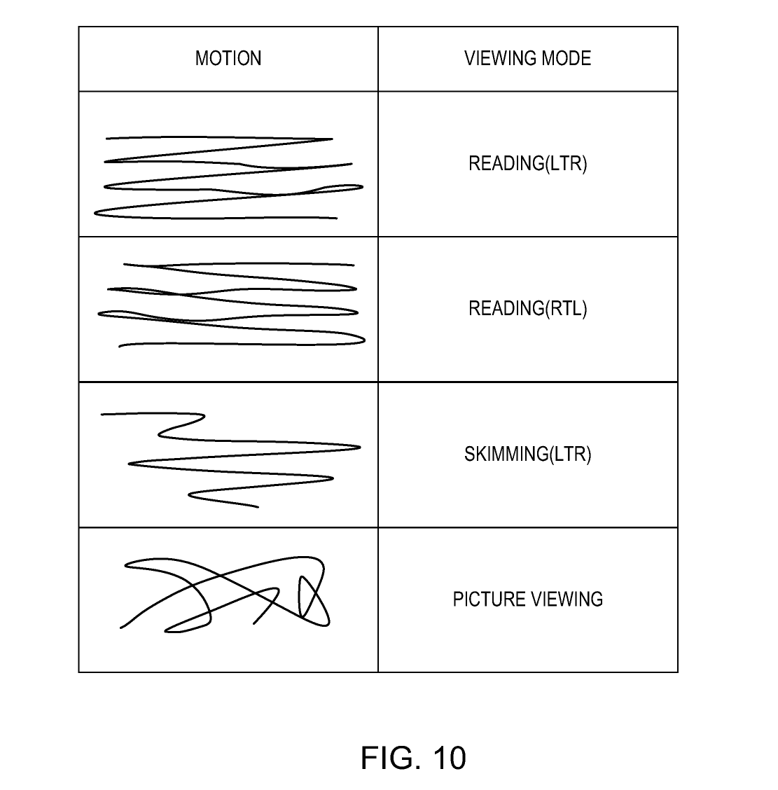

Reference is now additionally made to FIG. 10, which is a depiction of typical eye motions made by a user of the client device 200 of FIG. 1. A user of the client device 200 engaged in reading, for example, will have eye motions which are typically relatively constant, tracking left to right (or right to left for right to left oriented scripts, such as Hebrew, Urdu, Syraic, and Arabic). Skimming, conversely, follows a path similar to reading, albeit at a higher, and less uniform speed, with frequent “jumps”. Looking at a picture or a video, on the other hand, has a less uniform, less “left-to-right” motion.

When the processor determines that a change in viewing mode is detected, the behaviors designed into the content during the preparation phase are affected. In other words, the display of the different layers of content 910A, 920A, and 930A will either become more visible or more obtrusive, or alternatively, the different layers of content 910A, 920A, and 930A will become less visible or less obtrusive.

For example, the layer 920A containing the background picture 920 could be set to apply a fade and blur filter when moving from Picture Viewing mode to Reading mode.

The following table provides exemplary state changes and how such state changes might be used to modify the behavior of different layers of content 910A, 920A, and 930A.

| Layer | Previous Mode | New Mode | Action |
|---|---|---|---|
| Graphic Element | any | Picture | Reset Graphic Element |
| | | Viewing | |
| Graphic Element | any | Reading | Fade Graphic Element |
| | | | (50%) |
| | | | Blur Graphic Element |
| | | | (20%) |
| Graphic Element | any | Skimming | Fade Graphic Element |
| | | | (25%) |
| Article Text | any | Reading | Increase Font Weight |
| | | | (150%) |
| | | | Darken Font Color |
| Article Text | any | Skimming | Increase Font Weight |
| | | | (110%) |
| Teaser Text | Skimming | Reading | Decrease Font Weight |
| | | | (90%) |
| Teaser Text | Graphic | Skimming | Increase Font Weight |
| | Element | | (110%) |
| | Viewing | | |

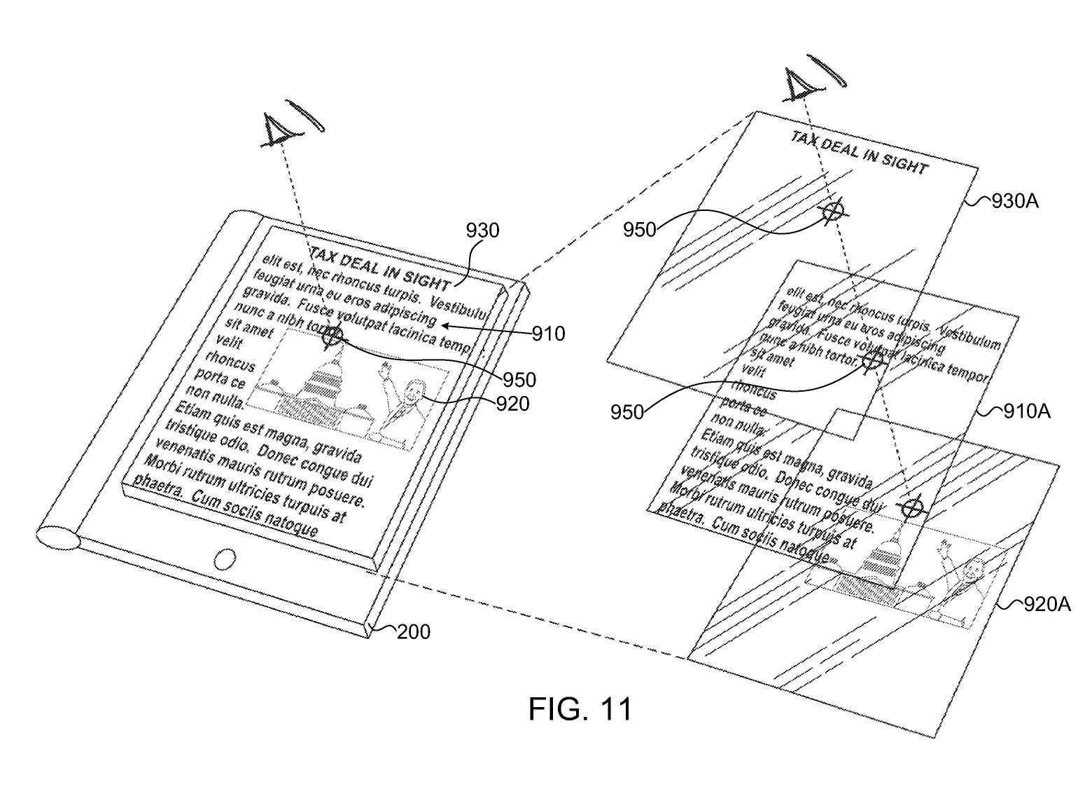

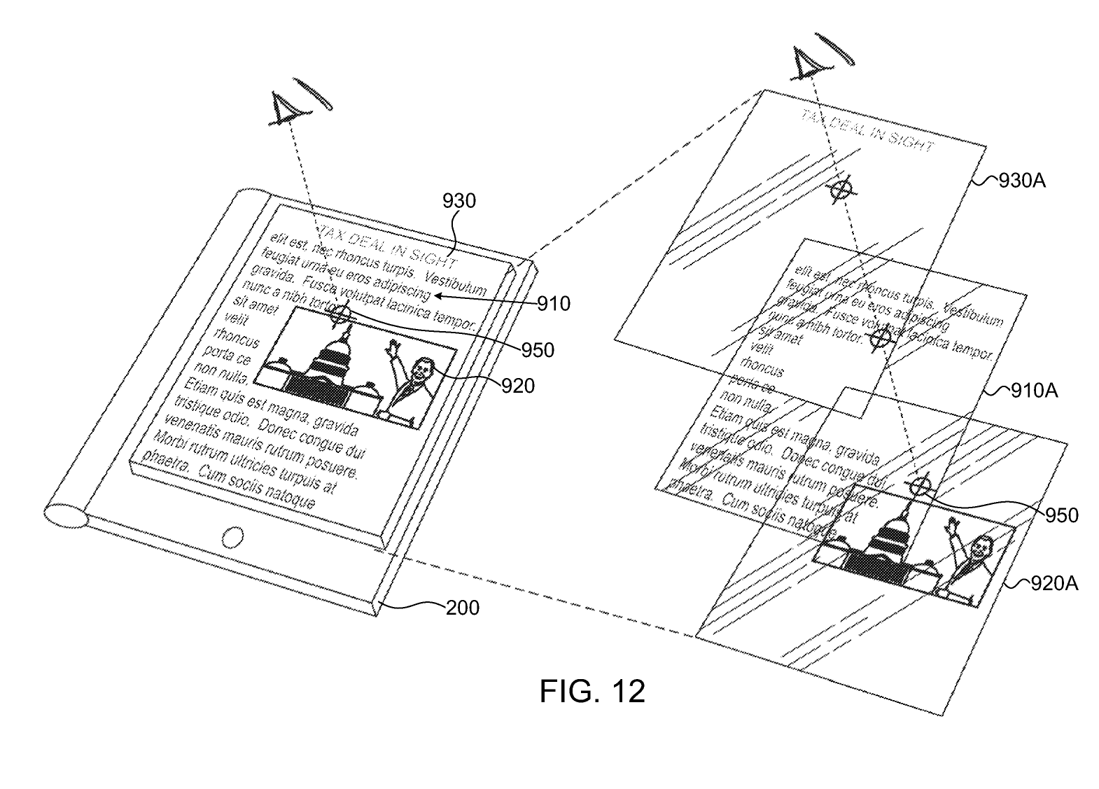

Reference is now made to FIGS. 11 and 12. FIG. 11 is a figurative depiction of the layered content elements of FIG. 9, wherein the user of the client device 200 is focusing on the displayed text. FIG. 12 is a figurative depiction of the layered content elements of FIG. 9, wherein the user of the client device 200 is focusing on the graphic element. In FIG. 11, the point 950 on which the user of the client device 200 is focusing on comprises the displayed text. As such, the text elements 910, 930 appear sharply on the display of the client device 200. On the other hand, the graphic element 920 appears faded. In FIG. 12, the point 950 on which the user of the client device 200 is focusing on comprises the graphic element 920. As such, the graphic element 920 appears sharply on the display of the client device 200. On the other hand, the text elements 910, 930 appear faded.

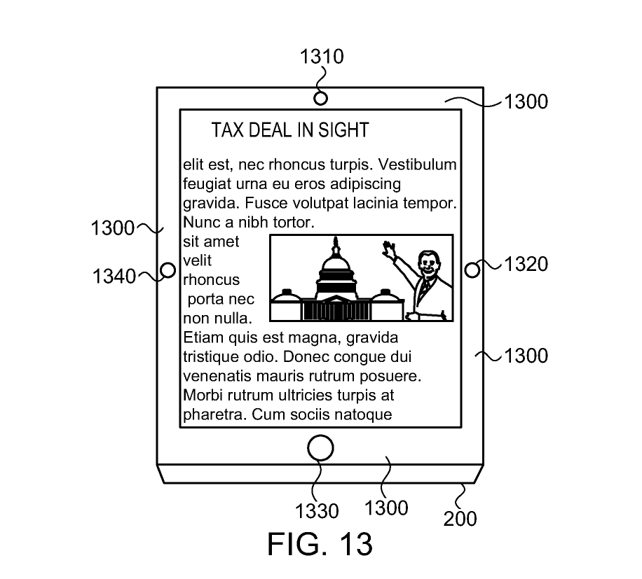

Reference is now made to FIG. 13, which is a depiction of an alternative embodiment of the client device 200 of FIG. 1. The client device 200 comprises a plurality of controls 1310, 1320, 1330, 1340. The controls 1310, 1320, 1330, 1340 are disposed in a frame area 1300 which surrounds the display of the client device 200. Although four controls are depicted in FIG. 13, it is appreciated that the depiction of four controls is for ease of depiction and description, and other number of controls may in fact be disposed in the number of controls may actually be disposed in the frame area 1300 surrounding the display of the client device 200.

The controls 1310, 1320, 1330, 1340 are operative to control the display of the client device 200. For example and without limiting the generality of the foregoing, if the user of the client device 200 fixates on one of the controls which are disposed in the frame area 1300, the image appearing on the display of the client device 200 scrolls in the direction of the control on which the user of the client device 200 fixates. Alternatively, the controls 1310, 1320, 1330, 1340 may not be scrolling controls for the display, but may be other controls operative to control the client device 200 as is well known in the art.

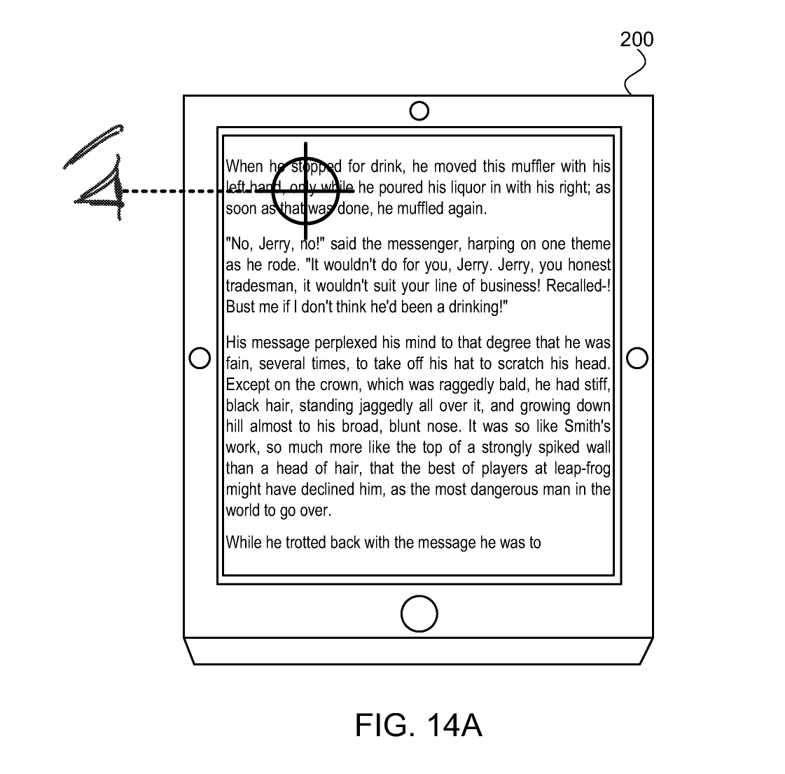

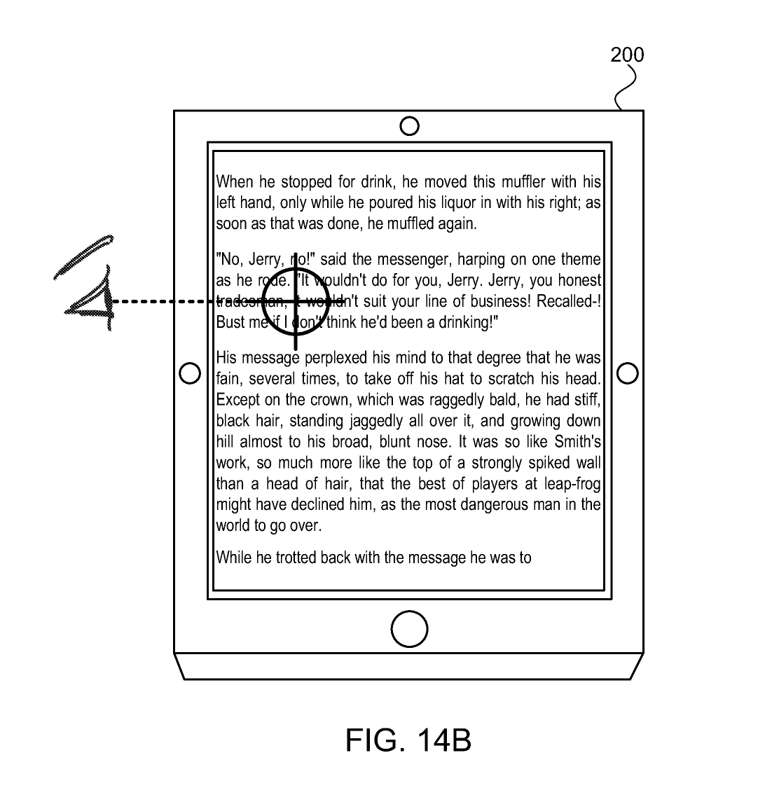

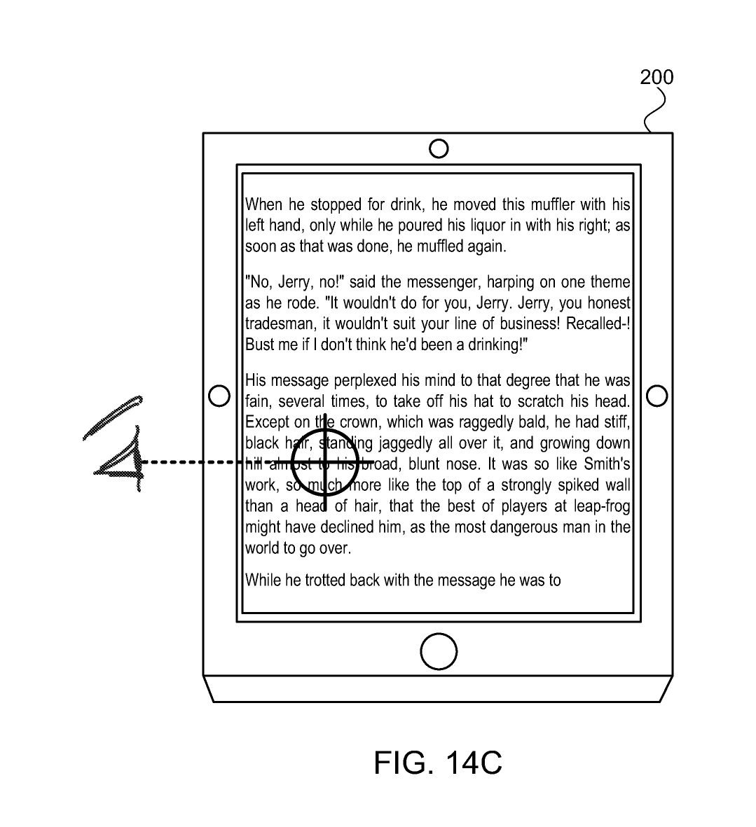

Reference is now made to FIGS. 14A, 14B, and 14C, which are a depiction of another alternative embodiment of the client device of FIG. 1. In FIGS. 14A, 14B, and 14C, the client device 200 is displaying a portion of Charles Dickens' A Tale of Two Cities. In FIGS. 14A, 14B, and 14C, three complete paragraphs are displayed.

Reference is now specifically made to FIG. 14A. In FIG. 14A, the user is depicted as focusing on the first paragraph displayed. The portion of the text displayed in the first paragraph displayed states, “When he stopped for drink, he moved this muffler with his left hand, only while he poured his liquor in with his right; as soon as that was done, he muffled again.” That is to say, Dickens describes how a character is pouring liquor. The document is marked up with metadata, the metadata identifying the text quoted above as being associated with a sound of liquid pouring.

A sound file is stored on the client device 200, the sound file comprises the sound of pouring liquid. The gaze tracking system 450 (FIG. 4) determines that the user is focusing on the first paragraph displayed. The gaze tracking system 450 (FIG. 4) inputs to the processor 340 (FIG. 4) that the user's gaze is focused on the first paragraph. The processor 340 (FIG. 4) determines that the metadata associates the first paragraph and the sound file. The processor triggers the sound file to play, and thus, as the user is reading the first paragraph, the user also hears the sound of liquid pouring playing over the speaker of the client device's 200.

Reference is now specifically made to FIG. 14B. In FIG. 14B, the user is depicted as focusing on the second paragraph displayed. The portion of the text displayed in the second paragraph displayed comprises a dialog:
“No, Jerry, no!” said the messenger, harping on one theme as he rode.
“It wouldn't do for you, Jerry. Jerry, you honest tradesman, it wouldn't suit your line of business! Recalled-! Bust me if I don't think he'd been a drinking!”

As was described above with reference to FIG. 14A, the document is marked up with metadata, the metadata identifying the text quoted above as comprising a dialog.

A second sound file is stored on the client device 200, the sound file comprising voices reciting the dialog. The gaze tracking system 450 (FIG. 4) determines that the user is focusing on the second paragraph displayed. The gaze tracking system 450 (FIG. 4) inputs to the processor 340 (FIG. 4) that the user's gaze is focused on the second paragraph. The processor 340 (FIG. 4) determines that the metadata associates the second paragraph and the second sound file. The processor triggers the second sound file to play, and thus, as the user is reading the second paragraph, the user also hears dialog playing over the speaker of the client device's 200.

Reference is now specifically made to FIG. 14C. In FIG. 14C, the user is depicted as focusing on the third paragraph displayed. The portion of the text displayed in the third paragraph displayed comprises neither description of sounds nor dialog.

No sound file is associated with the third paragraph displayed, nor is a sound file stored on the client device 200 to be played when the gaze tracking system 450 (FIG. 4) inputs to the processor 340 (FIG. 4) that the user's gaze is focused on the third paragraph.

It is appreciated that more complex sound files may be stored and associated with portions of displayed documents. For example, if two characters are discussing bird songs, then the sound file may comprise both the dialog in which the two characters are discussing bird songs, as well as singing of birds.

Reference is now made to FIG. 15, which is a pictorial illustration of transitioning between different secondary content items in accordance with the system of FIG. 1. In another embodiment of the present invention, a secondary content item, such as, but not limited to, an advertisement, is prepared so that for a first secondary content item, a second secondary content item is designated to be displayed after the first secondary content item. Additionally, the provider of the second secondary content item defines under what circumstances the displaying of the first secondary content item should transition to the displaying of the second secondary content item.

For example and without limiting the generality of the foregoing, if the first and second secondary content items are advertisements for a car, as depicted in FIG. 15, the first secondary content item 1510 may comprise a picture of the car. The second secondary content item 1520 may comprise the picture of the car, but now some text, such as an advertising slogan, may be displayed along with the picture. A third and fourth secondary content item 1530, 1540 may also be prepared and provided, for further transitions after the displaying of second secondary content item 1520. The third secondary content item 1530 may comprise a video of the car. The fourth secondary content item 1540 may comprise a table showing specifications of the car.

A provider, or other entity controlling the use of the device and system described herein, of the secondary content defines assets (i.e. video, audio, or text files) needed for the secondary content and defines the relationship between the various secondary content items. The definitions of the provider of the secondary content includes a sequence of the secondary content; that is to say which secondary content items transition into which other secondary content items, and under what circumstances.

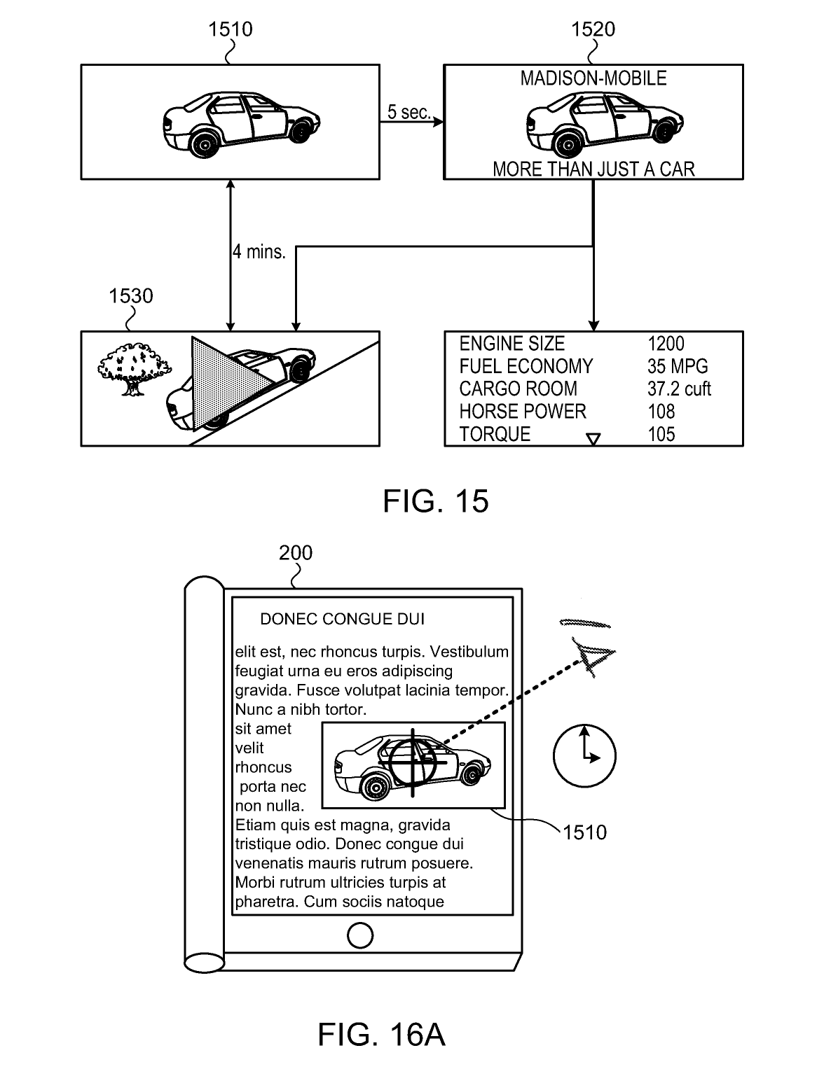

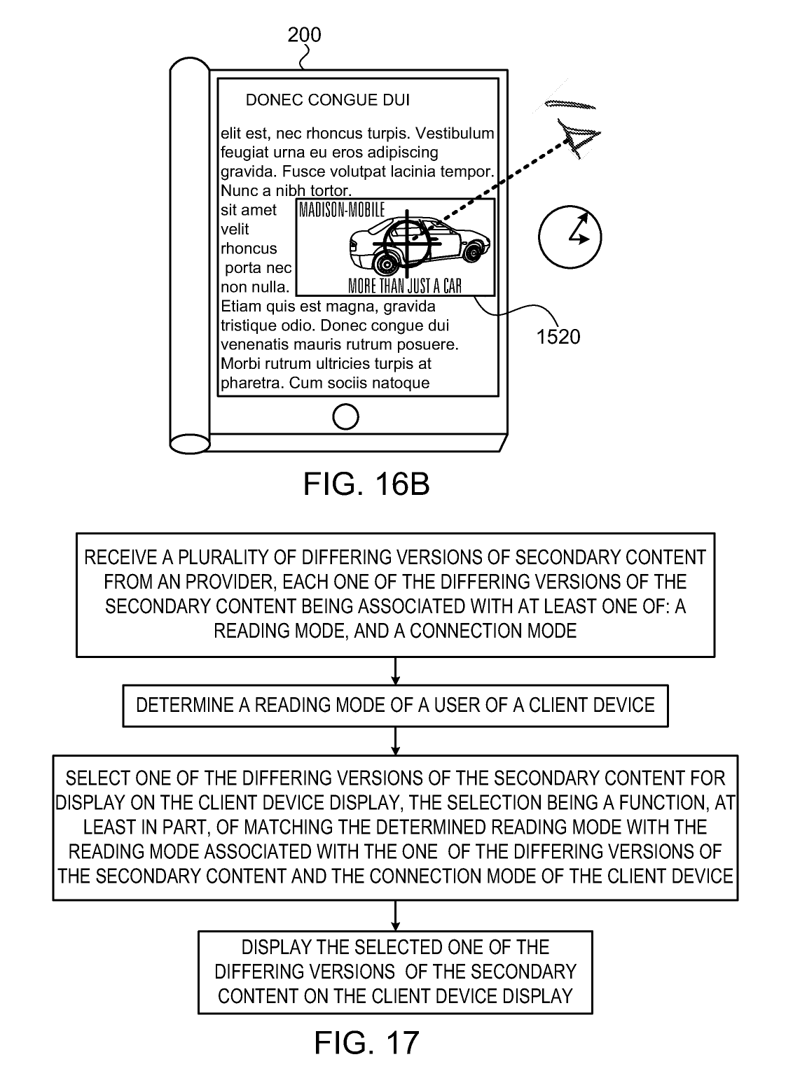

Reference is now additionally made to FIGS. 16A and 16B, which is a depiction of a transition between the first secondary content item 1510 and the second secondary content item 1520 displayed on the client device 200 of FIG. 1.

By way of example, in FIG. 16A, the first secondary content item 1510 is shown when the primary content with which the first secondary content item 1510 is associated is displayed. An exemplary rule for a transition to the second secondary content item 1520 might be that if the primary content with which the first secondary content item 1510 is associated is displayed continuously for four minutes, then the first secondary content item transitions to the third secondary content item 1530. On the other hand, if the gaze tracking system 430 (FIG. 4) comprised in the client device 200 determines that the user of the client device 200 is focusing on the first secondary content item 1510 for longer than five seconds, then the processor 340 (FIG. 4) produces an instruction to change the displayed first secondary content item 1510 to the second secondary content item 1520—as depicted in FIG. 16B.

An exemplary rule for the displaying of the second secondary content item 1520 would be that the second secondary content item 1520 is displayed each time after the first time the primary content with which the first secondary content item 1510 is associated is displayed (depicted in FIG. 16B). Additionally, if the user of the client device 200 sees a second primary item which is associated with one of the same first secondary content item 1510 or the same second secondary content item 1520, then the second secondary content item 1520 is also displayed. Furthermore, if the user of the client device 200 double taps the second secondary content item 1520, the second secondary content item 1520 transitions to the third secondary content item 1530. If the user of the client device 200 swipes the second secondary content item 1520, the second secondary content item 1520 transitions to the fourth secondary content item 1540.

Those skilled in the art will appreciate that secondary content items 1510, 1520, 1530, and 1540 will be delivered to the client device 200 with appropriate metadata, the metadata comprising the rules and transitions described herein above.

It is appreciated that when the secondary content items described herein comprise advertisements, that each advertising opportunity in a series of transitions would be sold as a package at a single inventory price.

In some embodiments of the present invention there might be a multiplicity of client devices which are operatively associated so that when the user is determined to be gazing or otherwise interacting with the display of one device (for instance a handheld device) an appropriate reaction may occur on one or more of a second device instead of or in addition to the appropriate reaction occurring on the primary device. For example and without limiting the generality of the foregoing, gazing at a handheld client device 200 may cause a display on a television to change channel, or, alternatively, the television may begin to play music, or display a specific advertisement, or related content. In still further embodiments, if no gaze is detected on the second device (such as the television), the outputting of content thereon may cease, thereby saving the use of additional bandwidth.

It is also appreciated that when multiple users are present, each one of the multiple users may have access to a set of common screens and each one of the of the multiple users may have access to a set of screens to which only the one particular user may have access.

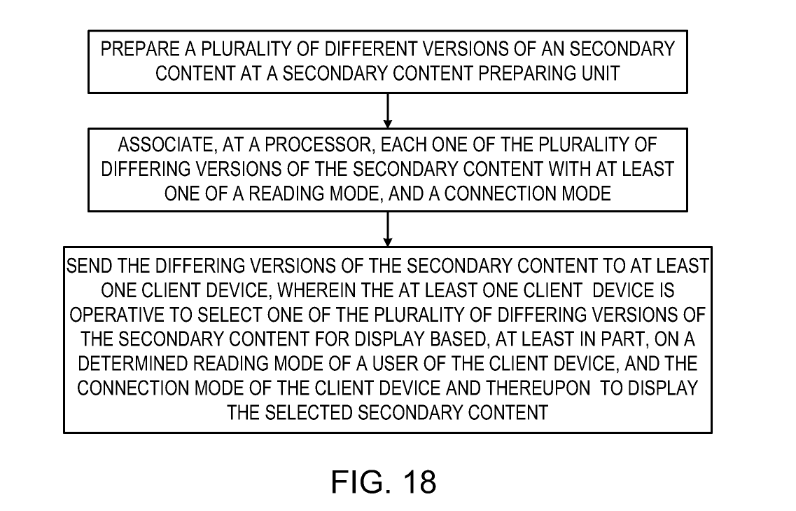

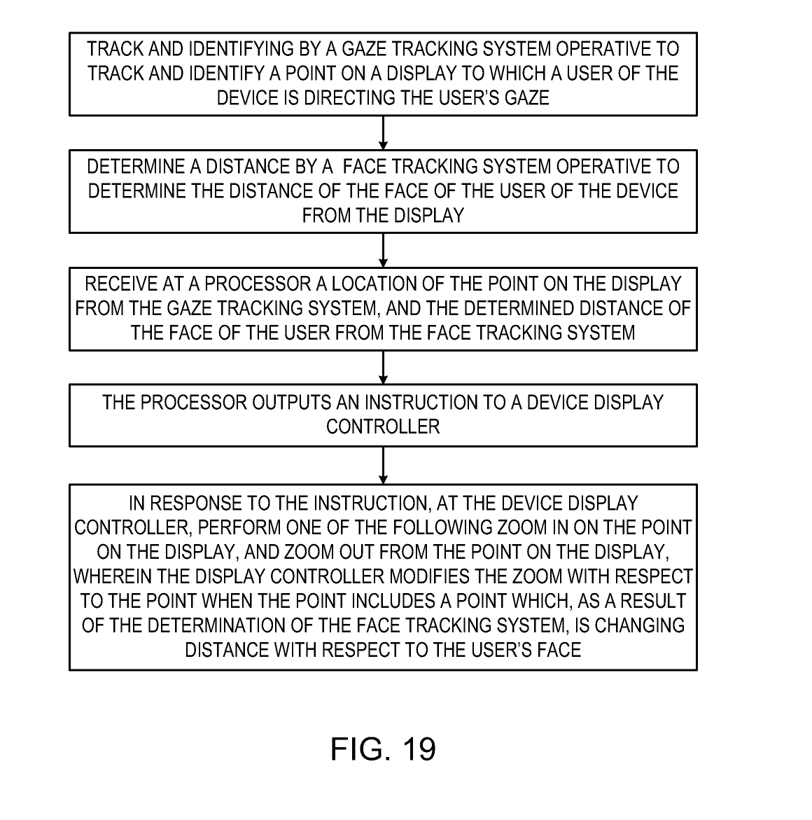

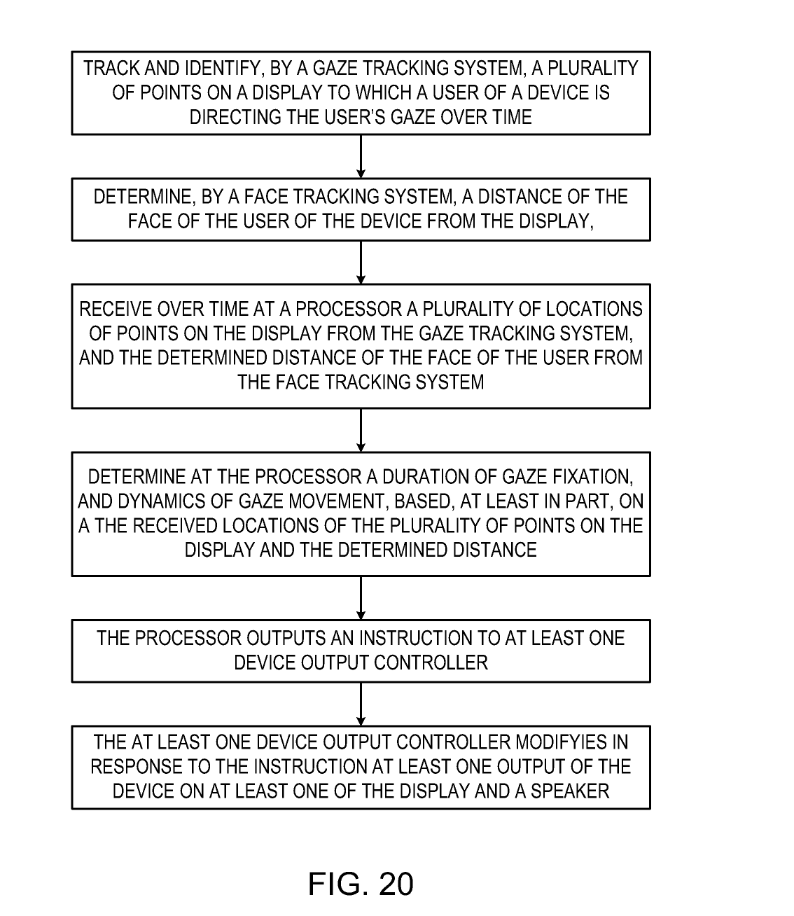

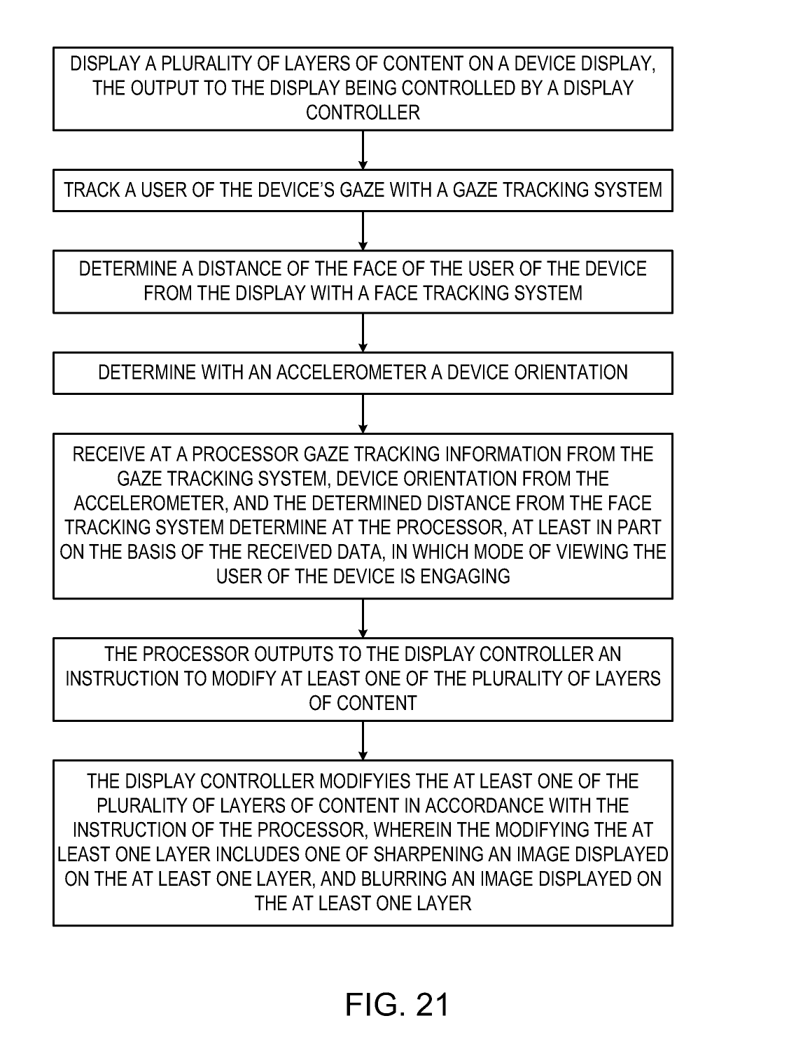

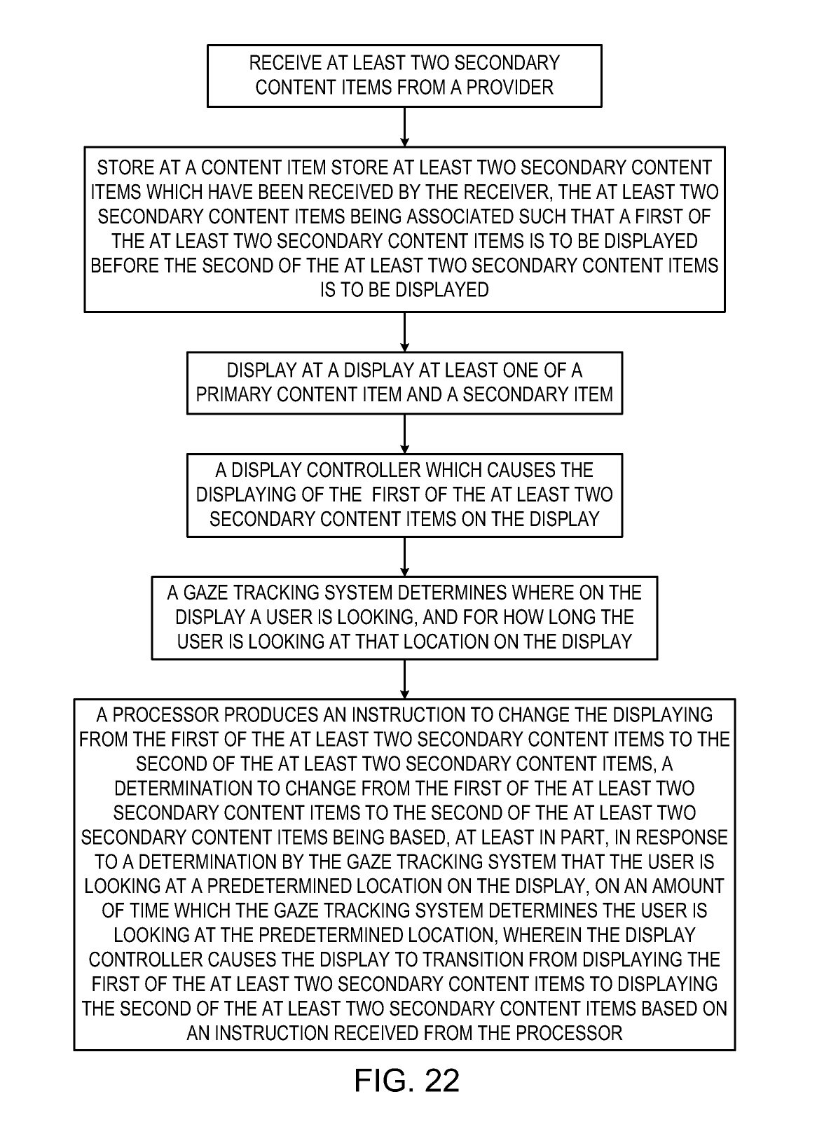

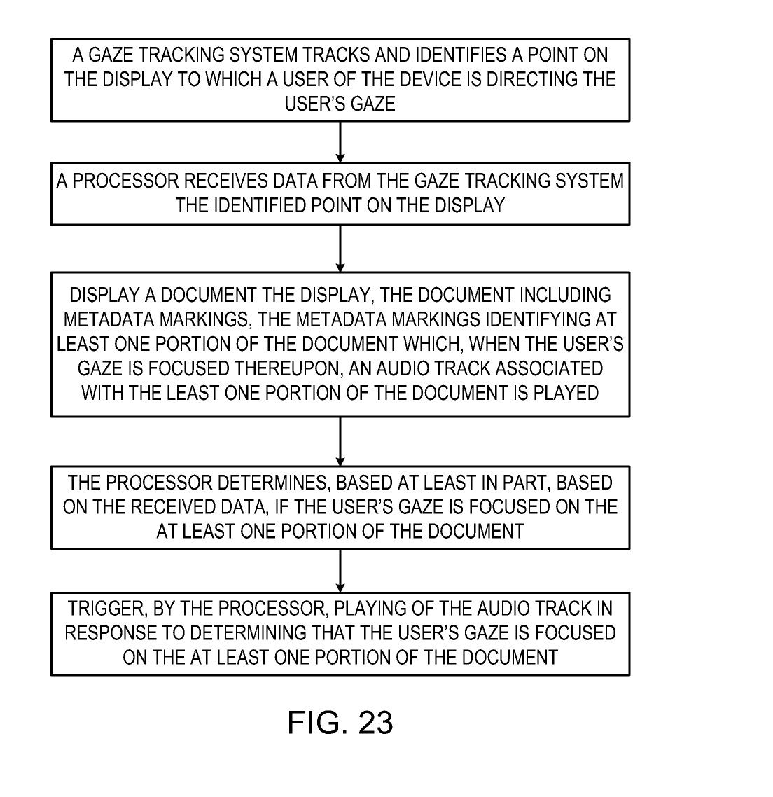

Reference is now made to FIGS. 17-23, which are simplified flowchart diagrams of preferred methods of operation of the system of FIG. 1. The method of FIGS. 17-23 is believed to be self explanatory in light of the above discussion.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product; on a tangible medium; or as a signal interpretable by an appropriate computer.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

1. A system comprising:
a client device comprising a receiver, a processor, a selector, and a display;
the receiver for receiving a plurality of differing versions of secondary content from an provider, each one of the differing versions of the secondary content being associated with at least one of:
a reading mode; and
a connection mode;
the processor operative to determine a reading mode of a user of a client device;
the selector for selecting one of the differing versions of the secondary content for display on the client device display, the selection being a function, at least in part, of matching the determined reading mode of the user with the reading mode associated with the one of the differing versions of the secondary content and the connection mode of the client device; and
the display for displaying the selected one of the differing versions of the secondary content.

2. The system according to claim 1 and also comprising selecting and displaying differing versions of primary content depending, at least in part, on the determined reading mode.

3. The system of claim 1 and wherein the different versions of the secondary content comprise any of:
content items which change into a different content item;
content items which occupy a fixed area on a display of the client;
content items which persist over more than one page; and
content comprising an audio component, the audio component persisting as the user of the client device changes pages.

4. The system of claim 1 and wherein the different versions of the secondary content comprise any of:
video content;
audio content;
automated files;
banner content;
different size content items;
different video playout rates;
static content; and
content which change when at least one of: the reading mode of the user of the client device changes; and the connection mode of the client device changes.

5. The system of claim 4 and wherein the secondary content is displayed on an alternative device.

6. The system of claim 1 and wherein the reading mode of the user of the client device comprises one of:
flipping quickly through pages displayed on the client device;
interfacing with the client device;
perusing content displayed on the client device; and
concentrated reading of the content displayed on the client device.

7. The system of claim 1 and wherein the processor determines the reading mode of the user, based at least in part on any of:
detecting and measuring a page turn rate;
detecting and measuring a time between page turns;
measuring average click speed;
measuring a speed of a finger on a touch-screen;
measuring a time between clicks on a page;
determining an activity of the user of the client device;
determining user interface activity, said user interface activity including, but not limited to searching, annotating, and highlighting text;
detecting one or both of movement or lack of movement of the client device;
detecting the focus of the user of the client device with a gaze tracking mechanism; and
detecting background noise.

8. The system according to claim 1 and wherein the connection mode is dependent on availability of any of:
bandwidth; and
connectivity to a network over which the secondary content is provided.

9. The system according to claim 1 and wherein the client device comprises one of:
a cell-phone;
an e-Reader;
a laptop computer;
a desktop computer;
a tablet computer;
a game console;
a music playing device; and
a video playing device.

10. A system for selecting a secondary content to display, the system comprising:
a secondary content preparing unit for preparing a plurality of different versions of an secondary content;
a processor for associating each one of the plurality of differing versions of the secondary content with at least one of:
a reading mode; and
a connection mode; and
a secondary content sender for sending the differing versions of the secondary content to at least one client device,
wherein the at least one client device is operative to select one of the plurality of differing versions of the secondary content for display based, at least in part, on a determined reading mode of a user of the client device, and the connection mode of the client device and thereupon to display the selected secondary content.

11. The system of claim 10 and wherein the different versions of the of the secondary content comprise any of:
content items which change into a different content item;
content items which occupy a fixed area on a display of the client;
content items which persist over more than one page; and
content items comprising an audio component, the audio component persisting as the user of the client device changes pages.

12. The system of claim 10 and wherein the different versions of the secondary content comprise any of:
video content;
audio content;
automated files;
banner content;
different size content items;
static content; and
content which changes when at least one of: the reading mode of the user of the client device changes; and the connection mode of the client device changes.

13. The system of claim 10 and wherein the reading mode of the user of the client device comprises one of:
flipping quickly through pages displayed on the client device;
interfacing with the client device;
perusing content displayed on the client device; and
concentrated reading of the content displayed on the client device.

14. The system of claim 10 and wherein the determined reading mode comprises a determination, based at least in part on any of:
one of detecting and measuring a page turn rate;
one of detecting and measuring a time between page turns;
measuring average click speed;
measuring a speed of a finger on a touch-screen;
measuring a time between clicks on a page;
determining an activity of the user of the client device;
determining user interface activity, said user interface activity including, but not limited to searching, annotating, and highlighting text;
detecting one or both of movement or lack of movement of the client device;
detecting the focus of the user of the client device with a gaze tracking mechanism; and
detecting background noise.

15. The system according to claim 10 and wherein the connection mode is dependent on availability of any of:
bandwidth; and
connectivity to a network over which the secondary content is provided.

16. The system according to claim 10 and wherein the client device comprises one of:
a cell-phone;
an e-Reader;
a laptop computer;
a desktop computer;
a tablet computer;
a music playing device; and
a video playing device.

17. A method comprising:
receiving at a receiver, of a client device, a plurality of differing versions of secondary content from a provider, the client device comprising a receiver, a processor, a selector, and a display, each one of the differing versions of the secondary content being associated with at least one of:
a reading mode; and
a connection mode;
determining at the processor a reading mode of a user of a client device;
selecting at the selector for selecting one of the differing versions of the secondary content for display on the client device display, the selection being a function, at least in part, of matching the determined reading mode of the user with the reading mode associated with the one of the differing versions of the secondary content and the connection mode of the client device; and
displaying the selected one of the differing versions of the secondary content on the display.

18. A method for selecting a secondary content to display, the method comprising:
preparing a plurality of different versions of an secondary content at a secondary content preparing unit;
associating, at a processor, each one of the plurality of differing versions of the secondary content with at least one of:
a reading mode; and
a connection mode; and
sending the differing versions of the secondary content to at least one client device,
wherein the at least one client device is operative to select one of the plurality of differing versions of the secondary content for display based, at least in part, on a determined reading mode of a user of the client device, and the connection mode of the client device and thereupon to display the selected secondary content.
